(19) United States
(12) Patent Application Publication
(10) Pub. No.: US 2026/0040396 A1
(43) Pub. Date: Feb. 5, 2026

(54) SYNCHRONIZED BUFFER STATUS REPORTS

(71) Applicant: Nokia Technologies Oy, Espoo (FI)

(72) Inventors: Benoist Pierre SEBIRE, Tokyo (JP); Chunli WU, Beijing (CN)

(21) Appl. No.: 19/100,525

(22) PCT Filed: Aug. 11, 2022
(86) PCT No.: PCT/CN2022/111877

§ 371 Date: Jan. 31, 2025

(51) Int. Cl. H04W 76/28; H04W 28/02

(52) U.S. Cl. CPC H04W 76/28; H04W 28/0278

(57) ABSTRACT

Systems, methods, apparatuses, and computer program products for synchronization of buffer status reports with respect to other communication events, such as discontinuous reception cycles are provided. For example, a method can include receiving a configuration from a network, wherein the configuration comprises a discontinuous reception configuration, a report configuration, or both the discontinuous reception configuration and a report configuration. The method can also include starting a discontinuous reception on duration timer for a user equipment in accordance with the discontinuous reception configuration. The method can also include deciding to conditionally send a report for the user equipment upon the start of the discontinuous reception on duration timer in accordance with the configuration. The method can further include sending the report to the network if an uplink grant for the user equipment is preset.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to synchronization of buffer status reports with respect to other communication events, such as discontinuous reception cycles.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus can include at least one processor and at least memory including computer program. The at least one memory and the computer program can be configured to, with the at least one processor, cause the apparatus at least to receive a configuration from a network, wherein the configuration comprises a discontinuous reception configuration, a report configuration, or both the discontinuous reception configuration and the report configuration; start a discontinuous reception on duration timer for a user equipment in accordance with the discontinuous reception configuration; trigger a report for the user equipment upon the start of the discontinuous reception on duration timer in accordance with the configuration; and send the report to the network if an uplink grant for the user equipment is present.

An embodiment may be directed to a method. The method can include receiving a configuration from a network, wherein the configuration comprises a discontinuous reception configuration, a report configuration, or both the discontinuous reception configuration and a report configuration; starting a discontinuous reception on duration timer for a user equipment in accordance with the discontinuous reception configuration; triggering a report for the user equipment upon the start of the discontinuous reception on duration timer in accordance with the configuration; and sending the report to the network if an uplink grant for the user equipment is present.

An embodiment can be directed to an apparatus. The apparatus can include means for receiving a configuration from a network, wherein the configuration comprises a discontinuous reception configuration, a report configuration, or both the discontinuous reception configuration and a report configuration; means for starting a discontinuous reception on duration timer for a user equipment in accordance with the discontinuous reception configuration; means for triggering a report for the user equipment upon the start of the discontinuous reception on duration timer in accordance with the configuration; and means for sending the report to the network if an uplink grant for the user equipment is preset.

### BRIEF DESCRIPTION OF THE DRAWINGS

For proper understanding of example embodiments, reference should be made to the accompanying drawings, wherein:

FIG. 1 illustrates a first example in which a grant can be given precisely at the beginning of each on duration;

FIG. 2 illustrates a second example in which a padding buffer status report is used;

FIG. 3 illustrates a third example in which a scheduler may miss an on duration;

FIG. 4 illustrates a rules flow of an implementation of certain embodiments;

FIG. 5 illustrates a rules flow of another implementation of certain embodiments;

FIG. 6 illustrates a signal flow diagram of a method according to certain embodiments;

FIG. 7A illustrates a method, according to certain embodiments;

FIG. 7B illustrates a further method, according to certain embodiments; and

FIG. 8 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing synchronization of buffer status reports with respect to other communication events, such as discontinuous reception cycles, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

The buffer status report (BSR) for new radio (NR) is specified in third generation partnership project (3GPP) technical specification (TS) 38.321 and BSR for LTE is specified in 3GPP TS 36.321. For ease of discussion, the following discussion focuses on the details of BSR in the context of the NR specifications, although the same principles can be applied to LTE or other systems, whether or not standardized.

In NR, a periodic buffer status report is triggered when the timer for periodic BSR, periodic BSR-Timer, expires. Moreover, in NR the timer for periodic BSR is started or restarted whenever a buffer status report has been triggered and that buffer status report is not a truncated buffer status report. A buffer status report can be considered to be not truncated when it contains a complete picture of the buffer status. In NR, truncated BSRs can include long or short truncated BSRs as well as extended long or short truncated BSRs. A medium access control (MAC) entity can be responsible for starting or restarting the timer for periodic BSR.

When discontinuous reception (DRX) is configured, it may be impossible to ensure that data transmission for every DRX cycle starts with a periodic BSR. It would be useful to have a periodic BSR for every DRX cycle in a number of scenarios, such as to feed information to a scheduler operating on a fixed time scale or to cope with services with a known pattern and for which too frequent scheduling request (SR) might not be useful, nor possible to assume. For example, there may be arrival of high priority data that only occurs in empty buffers and buffers may not always be empty. The gNB may, for example, decide to stop scheduling even if the UE buffers are known not to be empty.

There are at least three example scenarios, identified as first, second, and third for convenience only, in which a periodic BSR timer may be configured equal to the DRX cycle in order to try to have one BSR for every cycle.

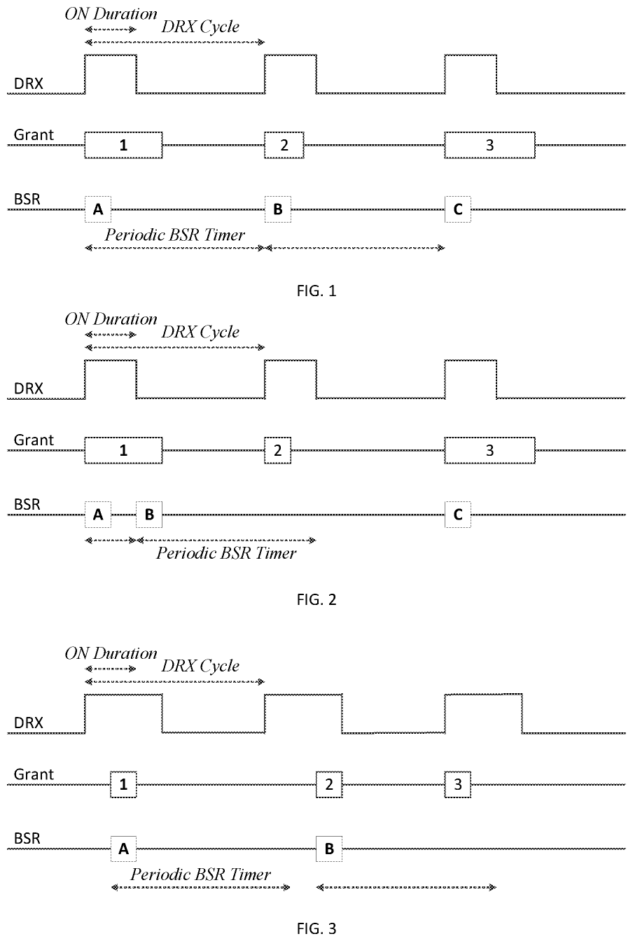

FIG. 1 illustrates a first example in which a grant can be given precisely at the beginning of each on duration. This may be viewed as a theoretical case. If a grant is always given precisely at the beginning of every on duration and no padding BSR other than truncated ones are sent at the end of a series of grant or data burst, it would theoretically be possible to align the periodic BSR reporting with the DRX cycle. Unfortunately, this only works on paper, as it is not possible to guarantee that only truncated BSRs are sent when a padding BSR is needed. This theoretical case is illustrated in FIG. 1, with BSRs A, B and C being aligned with the DRX cycle and being respectively sent at the beginning of the series of grants 1, 2 and 3. FIG. 2 illustrates a second example in which a padding buffer status report is used. Because the periodic BSR timer may be restarted when a non-truncated BSR is sent, the periodic BSR timer may be restarted at the end of every data burst. This padding case is depicted in FIG. 2, where the first series of grant (1) is concluded by a padding BSR (B) which restarts the periodic BSR timer. As a result, the periodic BSR timer is still running when the second grant arrives (2) and no periodic BSR is sent at the second occurrence of the on duration.

FIG. 3 illustrates a third example in which a scheduler may miss an on duration. When it is not possible for the scheduler to provide grants precisely at the start of every on duration, for example due to temporary overload, the periodic BSR timer might be started so late that the timer misses the next on duration. FIG. 3 illustrates such a case, namely a case in which the periodic BSR (B) sent for the second series of grant (2) starts the periodic BSR timer, which does not expire before the occurrence of the 3rd series of grant (3).

One approach that would solve the issues above would be to set the periodic BSR timer to such a short value that it would always have expired at the next on duration, regardless of how late that BSR timer starts in the previous cycle. Such an approach would significantly increase the periodic BSR overhead within the burst with the network (NW) continuously scheduling the UE, as the timer keeps on expiring. The current standardized values for periodic BSR and DRX cycle can be found in 3GPP TS 38.331.

In certain embodiments, the start of a drx-onDurationTimer for a DRX group can trigger a periodic BSR in addition to the start of the drx-onDurationTimer. Such an approach can ensure that a periodic BSR is sent at every on duration.

A wake up signal or downlink (DL) control information (DCI) with cyclic redundancy check (CRC) scrambled by power saving radio network temporary identity (PS-RNTI) (DCP) can be configured. When WUS/DCP is configured, then if drx-onDurationTimer is not started by WUS, the periodic BSR may not be triggered either, since the periodic BSR may not be automatically triggered by the WUS/DCP.

When a short DRX cycle is also configured, the BSR trigger can be limited to the long cycle or can include both long cycle and short cycle. Alternatively, the network can configure the UE to follow either behavior.

The periodic BSR trigger can be configured to take place every Nth start of the on duration timer, where N can be any integer, for example the value of N can be set to a single value of, for example, 2, or the value of N can be configurable on a range from, for example, 1 to 10. Other values can also be used.

The trigger can be linked to a particular logical channel (LCH) or logical channel group (LCG), either by data for the LCH/LCG being present in the uplink transport block, or by having data buffered for the LCH/LCG. This approach may be beneficial for a scheduler only interested in obtaining a regular update for a subset of the LCH/LCG.

The behavior could also be extended to power headroom report (PHR), or any medium access control (MAC) control element (CE) reporting information to the network. Thus, the additional trigger can apply to other MAC CEs.

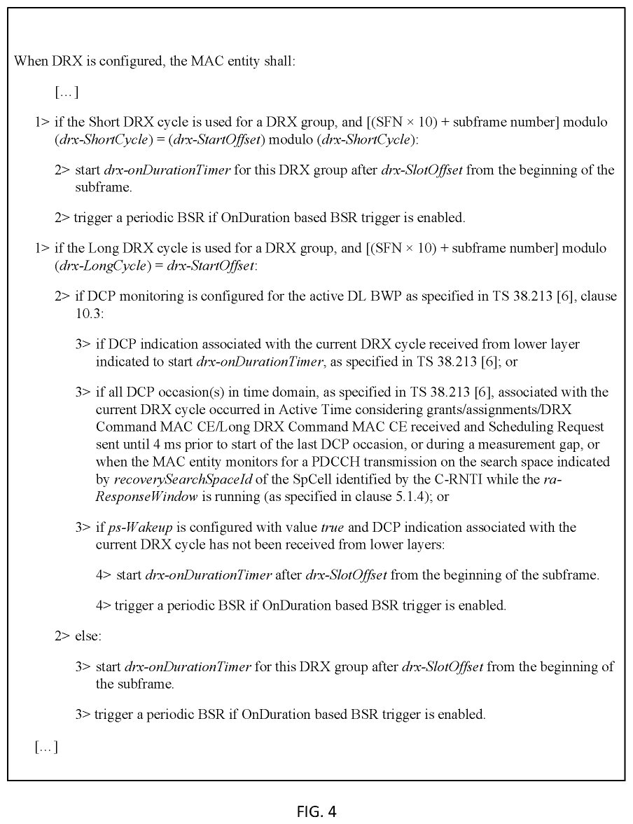

FIG. 4 illustrates a rules flow of an implementation of certain embodiments. As shown in FIG. 4, when DRX is configured, the MAC may, if the short DRX cycle is used for a DRX group, and [(SFN×10)+subframe number]modulo(drx-ShortCycle)=(drx-StartOffset)modulo(drx-ShortCycle), start drx-onDurationTimer for this DRX group after drx-SlotOffset from the beginning of the subframe and may trigger a BSR, such as a periodic BSR, if OnDuration based BSR trigger is enabled. Thus, in certain embodiments, a BSR can be triggered if OnDuration based BSR trigger is enabled when the short DRX cycle is used for a DRX group and [(SFN×10)+subframe number]modulo(drx-ShortCycle)=(drx-StartOffset)modulo(drx-ShortCycle). Although periodic BSR is used as an example, certain embodiments are applicable to other types of reports, such as aperiodic BSR as well as reports of other characteristics than buffer status, such as power headroom reports.

If the long DRX cycle is used for a DRX group, and [(SFN×10)+subframe number]modulo(drx-LongCycle)=drx-StartOffset, then if DCP monitoring is configured for the active DL BWP as specified in 3GPP TS 38.213, clause 10.3; and if DCP indication associated with the current DRX cycle received from lower layer indicated to start drx-onDurationTimer, or if all DCP occasion(s) in time domain associated with the current DRX cycle occurred in active time considering grants/assignments/DRX command MAC CE/long DRX command MAC CE received and a scheduling request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-ResponseWindow is running, or if ps-Wakeup is configured with value true and DCP indication associated with the current DRX cycle has not been received from lower layers, then the MAC may start drx-onDurationTimer after drx-SlotOffset from the beginning of the subframe and trigger a periodic BSR if OnDuration based BSR trigger is enabled. Thus, in certain embodiments, a periodic BSR can be triggered if OnDuration based BSR trigger is enabled when the long DRX cycle is used for a DRX group and [(SFN×10)+subframe number]modulo(drx-LongCycle)=(drx-StartOffset).

Otherwise, the MAC may start drx-onDurationTimer for this DRX group after drx-SlotOffset from the beginning of the subframe and trigger a periodic BSR if OnDuration based BSR trigger is enabled.

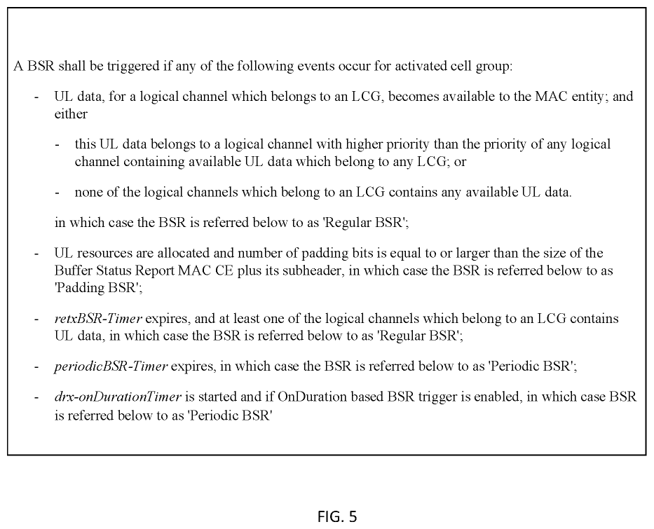

FIG. 5 illustrates a rules flow of another implementation of certain embodiments. FIG. 5 can be considered as an alternative implementation to the implementation of FIG. 4. For example, FIG. 4 may illustrate an implementation of rules as part of the specification of DRX, whereas FIG. 5 may illustrate an implementation of rules as part of the specification of buffer status reporting.

As shown in FIG. 5, a BSR may be triggered if any of the following events occur for activated cell group: uplink (UL) data, for a logical channel which belongs to an LCG, becomes available to the MAC entity and either this UL data belongs to a logical channel with higher priority than the priority of any logical channel containing available UL data which belong to any LCG or none of the logical channels which belong to an LCG contains any available UL data, in which case the BSR can be referred to as a regular BSR; or UL resources are allocated and number of padding bits is equal to or larger than the size of the Buffer Status Report MAC CE plus its subheader, in which case the BSR may be referred to as a padding BSR; or retxBSR-Timer expires, and at least one of the logical channels which belong to an LCG contains UL data, in which case the BSR can be referred to as a regular BSR; or periodic BSR-Timer expires, in which case the BSR can be referred to as a periodic BSR; or drx-onDurationTimer is started and if OnDuration based BSR trigger is enabled, the BSR can be referred to as a periodic BSR. A buffer status report may be provided in a MAC CE, and may indicate a current amount of data that is in a user equipment buffer awaiting transmission from the user equipment. In a short BSR, the BSR may include a logical channel group (LCG) identifier and the size of the corresponding buffer. In a long BSR, the buffer size of four LCGs may be sequentially provided. These are examples of BSR implementations, but other BSRs are also permitted.

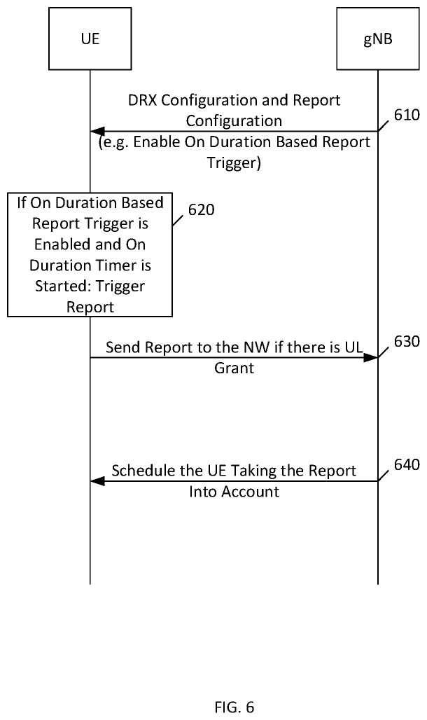

FIG. 6 illustrates a signal flow diagram of a method according to certain embodiments. As shown in FIG. 6, at 610 the gNB can configure the UE with a DRX configuration and a BSR configuration. It is not necessary that both configurations be provided in the same message. The gNB may provide a configuration that may include, enable on duration based BSR trigger. This configuration may be implemented as a BSR configuration (see FIG. 5 for example) or a DRX configuration (see FIG. 4 for example). At 620, if on duration based BSR trigger is enabled an on duration timer is started, then BSR can be triggered in the UE, for example by a MAC entity of the UE. Triggering a report here can refer to a decision to send the report, as distinct from the actual sending, which may be contingent on further conditions. After BSR is triggered, it will be reported when there is an UL grant. The content of the BSR can be or be carried in a MAC CE. Accordingly, at 630 the UE may send a BSR to the network, for example to the gNB, if there is an existing uplink grant. Thus, the presence of uplink grant may be the further contingency upon which the report actually sent. Then, at 640, the network may schedule the UE taking the BSR into account.

Thus, as illustrated in FIG. 6, the NW can enable or disable on duration based BSR trigger. The NW can enable/disable the trigger by providing a suitable configuration to the UE. If the trigger is enabled, the UE can trigger BSR when drx-onDurationTimer is started and can include the BSR in a MAC protocol data unit (PDU) if there is an UL grant. The NW can take the BSR into account when scheduling the UE.

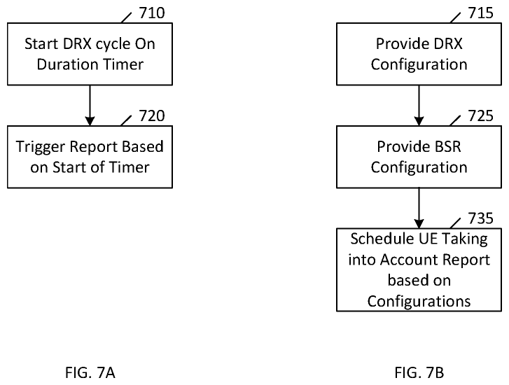

FIG. 7A illustrates a method according to certain embodiments. As shown in FIG. 7A, a method can include, at 710, starting a discontinuous reception on duration timer for a user equipment. The method can also include, at 720, triggering a report, such as a periodic buffer status report, for the user equipment upon the start of the discontinuous reception on duration timer.

When a wake up signal is configured to the user equipment, if the discontinuous reception on duration timer is not started by the wake up signal, then the periodic buffer status report is not triggered. When a short discontinuous reception cycle is also configured to the user equipment, the triggering the periodic buffer status report can be responsive to the start of the on duration timer of a long discontinuous reception cycle, for example only the start of the on duration timer of a long discontinuous reception cycle. Likewise, when a short discontinuous reception cycle is also configured to the user equipment, the triggering the periodic buffer status report can be responsive to the start of the on duration timer of the short discontinuous reception cycle, for example in addition to the on duration timer of a long discontinuous reception cycle.

The triggering of the periodic buffer status report can be conditioned on the start of the discontinuous reception on duration timer occurring a predetermined number of times. The predetermined number of times may be more than one in certain embodiments.

The triggering of the periodic buffer status report can be further conditioned on a particular subset of communication. The particular subset can be a particular logical channel or particular logical channel group. The further condition can be data being present in an uplink transport block for the particular subset or data being buffered for the particular subset.

The triggering of the periodic buffer status report can be performed in accordance with a configuration received at the user equipment from the network.

FIG. 7B illustrates a further method according to certain embodiments. As shown in FIG. 7B, the method can include, at 715, providing a discontinuous reception configuration to a user equipment. The method can further include, at 725, providing a buffer status report configuration to the user equipment. The discontinuous reception configuration and the buffer status configuration can cause the user equipment to start a discontinuous reception on duration timer for a user equipment and trigger a periodic buffer status report for the user equipment upon the start of the discontinuous reception on duration timer.

The method can also include, at 735, scheduling the user equipment taking into account a report, such as a buffer status report, received from the user equipment in accordance with the discontinuous reception configuration and buffer status report configuration.

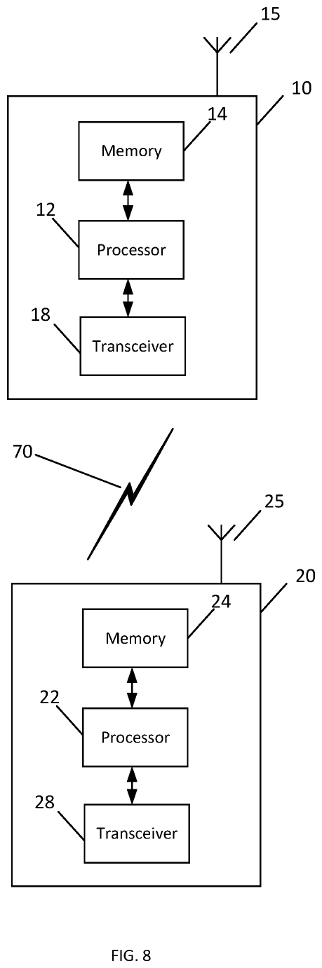

FIG. 8 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 8.

As illustrated in the example of FIG. 8, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 8, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to synchronization of buffer status reports with respect to other communication events, such as discontinuous reception cycles.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-7B, or any other method described herein. In some embodiments, as discussed herein, apparatus 10 may be configured to perform a procedure relating to providing synchronization of buffer status reports with respect to other communication events, such as discontinuous reception cycles, for example.

FIG. 8 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 8.

As illustrated in the example of FIG. 8, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 8, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-7B, or any other method described herein. For example, in an embodiment, apparatus 20 may be controlled to perform a process relating to providing synchronization of buffer status reports with respect to other communication events, such as discontinuous reception cycles, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and advantages. For example, in certain embodiments a periodic BSR can be triggered at beginning of every DRX cycle regardless of the periodicity of the burst, scheduler decisions, the periodic BSR timer configuration, or DRX cycle configurations. Additionally, in certain embodiments, there may be no extra overhead in case the NW does not schedule the UE in that DRX cycle, while if the NW schedules the UE during the OnDuration, the NW can get up to date buffer status information without configuration of very short values for periodic BSR timer. Thus, certain embodiments may enhance communications including for services like extended reality (XR).

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

BSR Buffer Status Report
DRX Discontinuous Reception
LCG Logical Channel Group
LCH Logical Channel
WUS Wake Up Signaling

1.-29. (canceled)

30. An apparatus, comprising:
at least one processor; and
at least one memory including computer program code, wherein the at least one memory and the computer program code are configured to, with the at least one processor, cause the apparatus at least to:
receive a configuration from a network, wherein the configuration comprises a discontinuous reception configuration, a report configuration, or both the discontinuous reception configuration and the report configuration;
start a discontinuous reception on duration timer for a user equipment in accordance with the discontinuous reception configuration;
trigger a report for the user equipment upon the start of the discontinuous reception on duration timer in accordance with the configuration, and based on a short discontinuous reception cycle being also configured to the user equipment, the triggering the report is responsive to the start of the discontinuous reception on duration timer of a long discontinuous reception cycle and the start of the discontinuous reception on duration timer of the short discontinuous reception cycle, wherein triggering the report is conditioned on the start of the discontinuous reception on duration timer occurring a predetermined number of times and on a particular subset of communication, wherein the particular subset comprises a particular logical channel or particular logical channel group, and wherein a further condition is data being present in an uplink transport block for the particular subset or data being buffered for the particular subset; and
send the report to the network if an uplink grant for the user equipment is present.

31. The apparatus of claim 30, wherein the report comprises a buffer status report or a power headroom report.

32. The apparatus of claim 31, wherein triggering the report comprises triggering a periodic report and the sending the report comprises an instance of a periodic report.

33. The apparatus of claim 32, wherein when a wake up signal is configured to the user equipment, if the discontinuous reception on duration timer is not started by the wake up signal, then the report is not triggered.

34. The apparatus of claim 33, wherein the report comprises a control element identifying a current amount of data waiting to be sent out from a buffer of the user equipment.

35. A system comprising:
an apparatus;
at least one processor; and
at least one memory including computer program code, wherein the at least one memory and the computer program code are configured to, with the at least one processor, cause the apparatus at least to:
receive a configuration from a network, wherein the configuration comprises a discontinuous reception configuration, a report configuration, or both the discontinuous reception configuration and the report configuration;
start a discontinuous reception on duration timer for a user equipment in accordance with the discontinuous reception configuration;
trigger a report for the user equipment upon the start of the discontinuous reception on duration timer in accordance with the configuration, and based on a short discontinuous reception cycle being also configured to the user equipment, the triggering the report is responsive to the start of the discontinuous reception on duration timer of a long discontinuous reception cycle and the start of the discontinuous reception on duration timer of the short discontinuous reception cycle, wherein triggering the report is conditioned on the start of the discontinuous reception on duration timer occurring a predetermined number of times and on a particular subset of communication, wherein the particular subset comprises a particular logical channel or particular logical channel group, and wherein a further condition is data being present in an uplink transport block for the particular subset or data being buffered for the particular subset; and
send the report to the network if an uplink grant for the user equipment is present.

36. The system of claim 35, wherein the report comprises a buffer status report or a power headroom report.

37. The system of claim 36, wherein triggering the report comprises triggering a periodic report and the sending the report comprises an instance of a periodic report.

38. The system of claim 37, wherein when a wake up signal is configured to the user equipment, if the discontinuous reception on duration timer is not started by the wake up signal, then the report is not triggered.

39. The system of claim 38, wherein the report comprises a control element identifying a current amount of data waiting to be sent out from a buffer of the user equipment.

40. A method comprising:
receiving a configuration from a network, wherein the configuration comprises a discontinuous reception configuration, a report configuration, or both the discontinuous reception configuration and the report configuration;
starting a discontinuous reception on duration timer for a user equipment in accordance with the discontinuous reception configuration;
triggering a report for the user equipment upon the start of the discontinuous reception on duration timer in accordance with the configuration, and based on a short discontinuous reception cycle being also configured to the user equipment, the triggering the report is responsive to the start of the discontinuous reception on duration timer of a long discontinuous reception cycle and the start of the discontinuous reception on duration timer of the short discontinuous reception cycle, wherein triggering the report is conditioned on the start of the discontinuous reception on duration timer occurring a predetermined number of times and on a particular subset of communication, wherein the particular subset comprises a particular logical channel or particular logical channel group, and wherein a further condition is data being present in an uplink transport block for the particular subset or data being buffered for the particular subset; and
sending the report to the network if an uplink grant for the user equipment is present.

41. The method of claim 40, wherein the report comprises a buffer status report or a power headroom report.

42. The method of claim 41, wherein triggering the report comprises triggering a periodic report and the sending the report comprises an instance of a periodic report.

43. The method of claim 42, wherein when a wake up signal is configured to the user equipment, if the discontinuous reception on duration timer is not started by the wake up signal, then the report is not triggered.

44. The method of claim 43, wherein the report comprises a control element identifying a current amount of data waiting to be sent out from a buffer of the user equipment.
